(19) United States
(12) Patent Application Publication
(10) Pub. No.: US 2010/0154012 A1
(43) Pub. Date: Jun. 17, 2010

(54) TELEVISION BOOKMARKING WITH MULTIPLATFORM DISTRIBUTION

(75) Inventors: Robert A. Clavenna, Lucas, TX (US); Paul V. Hubner, McKinney, TX (US); Kristopher A. Pate, Sachse, TX (US); Steven T. Archer, Dallas, TX (US)

Correspondence Address: VERIZON;PATENT MANAGEMENT GROUP, 1320 North Court House Road, 9th Floor, ARLINGTON, VA, 22201-2909, US

(73) Assignees: VERIZON BUSINESS NETWORK SERVICES INC., Ashburn, VA (US); MCI COMMUNICATIONS SERVICES, INC., Ashburn, VA (US); VERIZON CORPORATE RESOURCES GROUP LLC, Basking Ridge, NJ (US)

(21) Appl. No.: 12/334,683

(22) Filed: Dec. 15, 2008

(51) Int. Cl. H04N 7/173; H04M 1/00

(52) U.S. Cl. 725/109; 725/134; 455/556.1

(57) ABSTRACT

A system includes a content processing device in communication with a control device, the content processing device is configured to receive multi-media content from a network, and create a bookmark representing at least a portion of the multi-media content upon receiving a signal from the control device.

### BACKGROUND

Traditionally, consumer television and cable services were unidirectional in that television programming would originate from a central broadcasting source and be transmitted to the consumer in a one way, receive only manner. As technology has advanced, two-way communication using a content processing device, such as a set top box (STB), has become a standard feature. The most common application of bidirectional communication through an STB is pay-per-view (PPV) programming, and in some cases, Internet or phone access. Although PPV is commonplace and utilized by most consumers, there has been a general reluctance among consumers to embrace the television as a multi-functional bidirectional platform. This reluctance is in part due to awkward user interfaces and cumbersome navigation tools. As a result, it has been difficult for the marketing industry to fully explore television broadcasting as a marketing tool. By contrast, computer access to the Internet is widely accepted as a bidirectional tool not only for marketing and information purposes, but for sales. Unlike television, consumers have accepted the computer as an interactive, bidirectional tool.

The examples described hereinafter take into account these and other drawbacks associated with television as a bidirectional platform.

### BRIEF DESCRIPTION OF THE DRAWINGS

FIG. 1 illustrates an exemplary system for creating video bookmarks;

FIGS. 2A and 2B are flow charts illustrating an exemplary process for creating bookmarks; and

FIG. 3 illustrates an exemplary signal flow diagram in accordance with the exemplary process of FIGS. 2A and 2B.

### DETAILED DESCRIPTION

### Overview

A bidirectional system and method for marking portions of a television broadcast (i.e., bookmarks) generally includes a content processing device, one or more networks and a plurality of servers. In an exemplary approach, television broadcast signals are sent to a content processing device located at a subscriber premises. Using a television control device configured to control the content processing device, a user can mark a portion of the television broadcast by selecting a button on the control device, creating a bookmark. The contents of the bookmark (i.e., bookmark data), without limitation, can include multi-media content such as audio and video (A/V), and embedded metadata such as time, channel and user information. The bookmark data may be stored in the content processing device and/or transmitted through a service provider network to a remote server for storage and later recall using an interactive platform, such as, but not limited to, an Internet connected device.

In another exemplary approach, the television broadcast signals are concurrently transmitted to a network content processing device located within the service provider network. Like the aforementioned, a user creates a bookmark using the television control device in connection with the content processing device at the subscriber premises. Using this approach, the bookmark data created in the content processing device contains no multi-media content, only marking related metadata such as, but not limited to, the date, time and channel associated with the bookmark. Without AN content, the size of the bookmark, from a memory consumption and transmission standpoint, is significantly reduced. The non-A/V bookmark data is transmitted from the content processing device through the service provider network to a remote server, where the metadata of the non-A/V bookmark data is correlated to the audio and video of the broadcast signals stored in the network content processing device. At this point, the bookmark data is complete in that it contains all multi-media content and metadata associated with the user created bookmark.

### Exemplary System

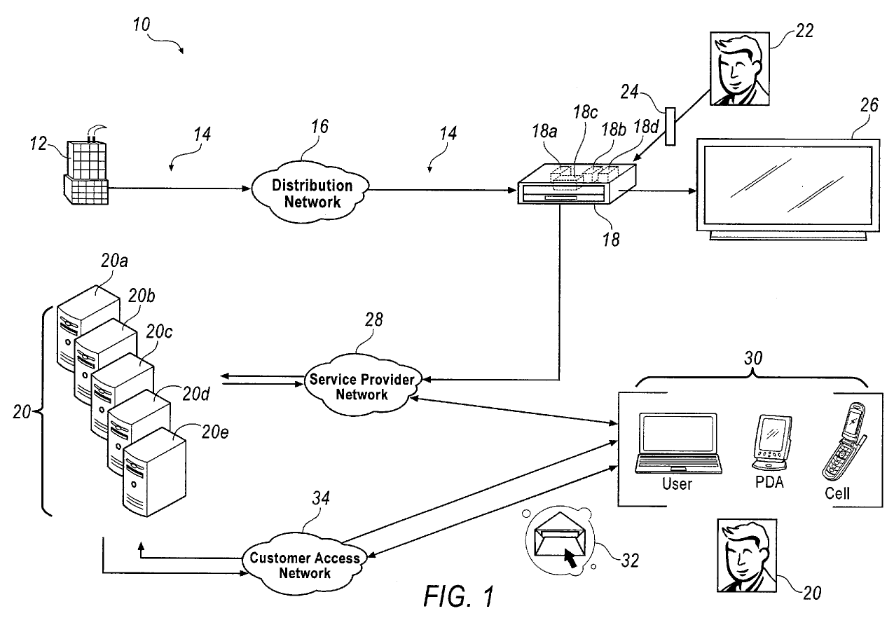

FIG. 1 illustrates an exemplary system 10 for bookmarking a portion of a broadcast that includes a central broadcasting source 12 configured to transmit television signals 14 to a television distribution network 16. The television signals 14 contain multi-media content, including, but not limited to, any combination of images, audio, and video. The television signals 14 may also include embedded metadata and other information relating to content sources such as commercial, marketing or sponsor information.

In this context, metadata refers to all data associated with a television signal feed (e.g., television signals 14) and according to existing technology standards, such as, but not limited to, Electronic Industries Alliance EIA-766, metadata is provided for every aired program or broadcast. Electronic Industries Alliance EIA-766 is part of the National Television System Committee (NTSC), which is the standardization body that adopts standards for analog television systems in the United States. With most existing technology standards metadata is provided in the form of time, station identification, program rating, channel and program guide, and predefined user information, to name a few. Predefined user information may include subscriber information relating to the particular equipment being used, the subscriber name, billing information and network connection information. Other information that is part of a specific program feed includes video, audio and image resolution content. In digital video networks using an ATSC standard, similar information is provided in a picture user data region. Similar to NTSC, ATSC represents the Advanced Television Systems Committee that adopts standards for the digital television format. Metadata in general is embedded within the television signal 14, either as a part of a vertical blanking interval (i.e., the time interval between frames in an analog transmission), or transmitted as a whole if part of a digital transmission. Metadata may also be transmitted and gathered from a closed-captioning function, which provides a real time transcript of the audio portions of the program content.

Referring again to FIG. 1, from the television distribution network 16, television signals 14 can be transmitted to a consumer content processing device 18, such as a set top box (STB), and/or to one of a plurality of servers 20. Content processing device 18 may be controlled by a user 22 through a television control device 24, thereby facilitating the selection and playing of multi-media content through a display device 26, such as a television. The content processing device 18 is generally referred to as a “smart” device in that it may include encoding, decoding, processing and data storage capabilities. Specifically, content processing device 18 may generally include an encoder 18a, a decoder 18b, a processor 18c and memory module 18d.

The encoder 18a converts information from television format into a lower resolution format used to create a bookmark. The encoder 18a is also configured to perform a continuous (or rolling) low resolution capture of the video and audio stream from television signal 14 to a buffer in memory module 18d. In this context, a rolling capture refers to the capture of a specific duration of video and audio that when reached, shifts the oldest information out of the memory module 18d to make room for the newest information. The decoder 18b decodes (i.e., converts) information from both a broadcast television format, including reading embedded closed captioning text data such as program information, and stored low resolution formats (e.g., from a previously stored bookmark) to a television output format for viewing on a display device. The processor 18c is configured to correlate encoded video data from encoder 18a with associated information data from decoder 18b. The decoded information (e.g., metadata) is stored in the memory module 18d for later retrieval.

In one exemplary approach, the plurality of servers 20 includes, for example, an encoding server 20a, authorization (i.e., registration) server 20b, storage (i.e., database) server 20c, a front end (i.e., web portal) server 20d and search server 20e. The servers 20 are in communication with content processing device 18 through a network 28. In one example, network 28 is service provider network, however, is should be understood that network 28 may be any data transport network capable of supporting data transfer from content processing device 18. The servers 20 are configured to collect and store the bookmark data from the content processing device 18 for future retrieval through an interactive platform 30, such as, but not limited to, a personal computer, a personal digital assistant (PDA) or a cell phone (i.e., wireless phone). The servers 20 are in communication with interactive platform 30 through network 28, or another data transport network 34 (e.g., the Internet).

Using the television control device 24, user 22 can select a portion or segment of a program to mark and retain for future access or reference. In an exemplary approach, while viewing the multi-media content on the display device 26, the user 22 marks a desired segment or portion of the broadcast by selecting a bookmark button, or other selection mechanism, on the television control device 24. Because the content processing device 18 includes the rolling capture function, selecting the bookmark button multiple times allows the user 22 to sequence back through previously captured frames to choose the beginning of the bookmark. Each successive press of the bookmark button shows the user 22 a screenshot from an increased amount of time back from the current location in the program. In this context, the bookmarked portion or segment of a program refers to the captured frames and segments relating to a specific time interval surrounding the bookmark request (i.e., selecting the bookmark button). In one exemplary approach, this time interval may be approximately fifteen seconds, but can be increased or decreased by the service provider, through a programming update to the content processing device 18, pre-specified by the user, or at the time the user selects the bookmark function.

In an alternative approach, the user 22 presses the button once at a time T. This action marks a desired segment from a time period T−˜10 second (definable by the service provider) to T+˜20 sec (also definable by the service provider). Using this approach, selecting the bookmark button multiple times creates multiple bookmarks having the same predetermined time period.

For each bookmark, the content processing device 18 creates a set of bookmark data that includes, but may not be limited to, the content processing device's 18 unit identifier (i.e., a serial number or other unique, identifiable identification), a copy of all of the current metadata stored in the memory module 18d and the contents of the rolling capture buffer. The bookmark data may be in the form of a data file and may reside on the content processing device 18 and/or be sent to one of the plurality of servers 20.

In an alternative approach, the content processing device 18 creates the bookmark as described above, without the audio/video (A/V) multi-media content. In this configuration, television signals 14 are concurrently transmitted to both the content processing device 18 and the encoding server 20a. The encoding server 20a includes a network content processing device configured to continuously capture and record multi-media content and embedded data from the broadcast television signals 14 without any specific customer data. In this way, when more than one subscriber creates a bookmark, the same A/V content can be associated with both subscribers in an encoder 20a database, which saves server space and reduces the transmission size of the bookmark data from the content processing device 18 to the plurality of servers 20.

Transmission of the bookmark to the servers 20 can be accomplished by any known method for transmitting data across a network. For example, one exemplary approach includes transmitting the data files through one of several burst transmission types employed by a TCP/IP datagram structure. In addition, several different application layer protocols may be used such as SQL statements or http POST to transfer the data to servers 20, wherein SQL (Structured Query Language) is a database computer language designed for retrieval and management of data, and http is a communications protocol for the transfer of information on the Internet and POST refers to the method used to submits data to be processed to the identified resource.

The servers 20 are configured to periodically send a notification 32 of existing or new bookmarks to the user 22 through data transport network 34 (e.g., the Internet) or through service provider network 28. The time interval for sending the notifications is definable by either the service provider or the user 22. The notification generally includes a brief summary of the bookmark data and may include, for example, a still image, the show title, the time, the date, the channel and a link to an Internet-based service such as a web interface or portal. The notification can be sent to the user 22 using any push technology capable of transmitting through a network, such as, but not limited to, email, instant messaging, test messaging, short message service (SMS), set top box notifications, etc. The user 22 may also access the stored bookmarks using the web interface or portal by logging into a user account. In this way, the user 22 can access all stored bookmark data sets and configure or manage system options such as, but not limited to, the frequency of the notification summaries and the number of stored bookmarks displayed (e.g., the length of the bookmark file queue). System options may also be accessible and configurable by the user 22 through the content processing device 18. For example, the content processing device 18 allows the user 22 to interact with bookmarks saved on the network servers 20, providing playback on demand and the ability to direct the servers 20 to send the bookmark data to other interactive platforms 30 on the network such as wireless phones or PDAs. In most cases, the bookmark data is already in a distributable compressed format for display on most interactive platforms, however, further transcoding of the bookmark data may be provided in the encoding server 20a for targeted display devices.

In one exemplary application, the bookmark data transmitted with the television signals may include audio files, video clips, or other embedded text such as advertisements or marketing and sales information related to items or products being viewed during that particular section of the programming. For example, if a user is watching a television program and notices a particular piece of clothing worn by one of the actors, the user 22 can mark that particular segment of the program using the bookmark button on the television control device 24. As another example, the user may be watching a cooking show and wants to know more information about the knives being used on the show. By selecting the bookmark button and creating a bookmark while the knives are in view, information relating to that segment, which may include marketing and merchandise information, is gathered along with the other metadata and forwarded to the servers 20, as described above.

As shown in FIG. 1, servers 20 may include a search engine embodied in search server 20e configured to perform a query on at least a portion of the text data in the bookmark data. This search can be performed at the time of requesting the bookmark review and displayed along with the visual media in the notification 32. Embedded search results provide the user 22 the ability to gather bookmark-driven interactive search results, and make direct purchases from linked vendors or advertising partners online. The search engine can employ any known search protocol and can be performed based on a variety of search criteria. For example, the system 10 can be configured to perform an initial cursory search of basic terms of embedded text within the captured segment and delivered to the user 22 with the notification 32. In addition, the user 22 can initiate a more exhaustive search on selected terms or concepts when accessing the information through the web interface or portal.

Computing devices such as content processing device 18, interactive platforms 30, servers 20, etc. may employ any of a number of computer operating systems, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Content processing device 18 is generally a specialized device for receiving video signals 14 from central broadcasting source 12 via television distribution network 16, and may be provided with a proprietary or specialized operating system other than those enumerated above. For example, in one embodiment, content processing device 18 is an set top box (STB) provided with a real time operating system (RTOS) such as is known. However, it is to be understood that content processing device 18 may be a computing device such as one of those enumerated above, so long as the computing device is capable of receiving television signals 14 from network 16, and also is capable of storing executable instructions and communicating with the servers 20.

Computing devices generally each include instructions executable by one or more computing devices such as those listed above. Computer-executable instructions may be compiled or interpreted from computer programs created using a variety of known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

### Exemplary Process

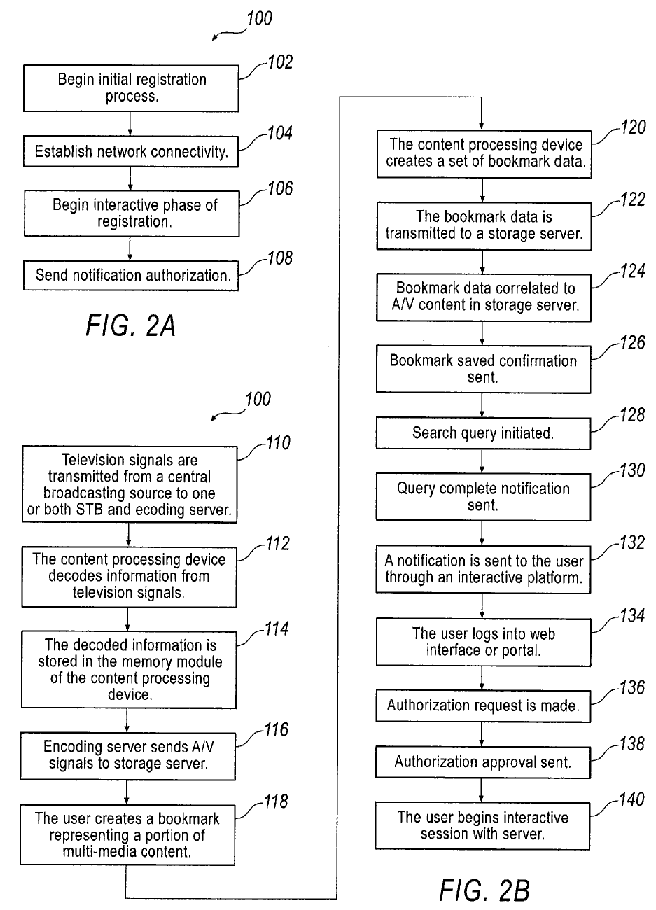

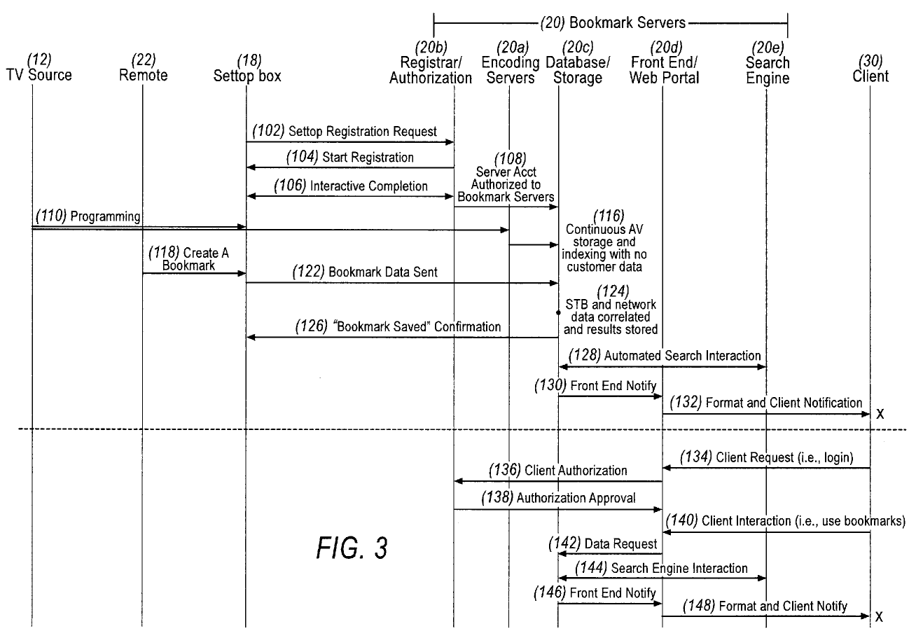

FIGS. 2A, 2B and 3 illustrate an exemplary registration and bookmarking process 100 and corresponding signal flow diagram 200, respectively, employing the system 10 shown in FIG. 1. For illustrative purposes, the content processing device 18 will be referred to hereinafter with respect to this exemplary process as a set top box (STB) 18. When a new STB 18 is added to the system 10, an initial registration process between the STB 18 and registration and authentication server 20b begins at step 102, with a registration request from STB 18 when the device is initially turned on (initial boot). Network connectivity is established and the registration process begins at step 104. An interactive phase of the registration process begins at step 106, wherein a unique hardware identification for the STB 18 is transmitted and verified as being active with a particular service provider. In addition, the user 22 at step 106 completes an on-screen account registration for the STB 18 that includes, for example, the user account number, the user identification number and user password associated with subsequent access to front end/web portal server 20d. Upon completion of the registration process, a notification is sent at step 108 to storage server 20c confirming authorization for STB 18 to create and store bookmarks.

Normal operation begins at step 110 when television signals 14 from a central broadcasting source 12 are transmitted to one or both of the STB 18 and encoding server 20a through distribution network 16. The television signals 14 sent to the STB 18 contain multi-media content, including, but not limited to, any combination of images, audio, video, embedded metadata and other information relating to content sources such as commercial, marketing or sponsor information. The content processing device 18 decodes information from the television signal 14 at step 112, and stores the selected information into memory module 18d at step 114. The television signals 14 sent to encoding server 20a contain the same content and information as those signals 14 sent to STB 18. The information encoded at encoding server 20a contain no customer identifying data. At step 116, the encoding server 20a sends a continuous stream of the A/V signals 14 without the customer data to storage server 20c for storage and indexing.

At step 118, the user 22 creates a bookmark to mark a portion or segment of a broadcast by selecting a designated button on a control device 24, such as a remote control. At step 120, the STB 18 creates a set of bookmark data relating to the bookmark, which includes the STB's 18 unit identifier (i.e., a serial number or other unique, identifiable identification), a copy of all of the current metadata stored in the memory module 18d and, in one approach, the contents of a rolling capture buffer containing the A/V content associated with the bookmark. Using another approach, the bookmark data would not include the A/V content.

The bookmark data, in either of the above-described approaches (i.e., with or without A/V), is transmitted from STB 18 at step 122 to storage server 20c for storage and future retrieval. If the bookmark data does not contain A/V content, at step 124 bookmark data from the STB 18 such as, but not limited to, the time, day, channel information, etc., are correlated to indexed A/V content stored at step 116 in storage server 20c. The results, which now contain a set of bookmark data containing all required data including audio and video. At step 126, a confirmation notification that the bookmark is saved is transmitted from the storage server 20c to the STB 18.

After the bookmark confirmation has been sent, a first level query is initiated at step 128 on the textual portion of the embedded bookmark data between storage server 20c and search server 20e. At step 130, a notification indicating the completion of the search query is sent to the front end/web portal server 20d, which is a customer end interface device that provides access to customer interactive resources such as, but not limited, search engine interfaces such as Google™ and Yahoo™. At step 132, front end/web portal server 20d formats the search query and bookmark data and sends a notification 32 to the user 22 through one of the interactive platforms 30. The notification 32 may include a brief summary of the saved bookmark data files including, but not limited to, a still image, the show title, channel, time and date.

At step 134, the user logs into (using the previously registered password) front end/web portal server 20d using a web interface or portal, or through a link in the previously sent notification (e.g., at step 132). At steps 136, a request is made by the front end server 20d to the registration server 20b to verify that the user 22 is authorized to access the system. An authorization approval is sent as step 138 verifying that user 22 has authorization to access the system. At step 140, the user 22 begins an interactive session with the front end server 20d, which may include at step 142 a request for additional information from the storage server 20c. This request may further initiate at step 144 a search query between the storage server 20c and the search server 20e. The results are sent at step 146 to the front end server 20d and formatted and sent to the user at step 148 through interactive platform 30.

Reference in the specification to “one example,” “an example,” “one approach,” or “an application” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising:
a content processing device in communication with a control device, said content processing device being configured to receive multi-media content from a first network, and create a bookmark representing at least a portion of the multi-media content upon receiving a signal from the control device.

2. The system of claim 2, wherein the multi-media content includes embedded metadata.

3. The system of claim 3, wherein the embedded metadata includes at least one of a time, station identification, program information and predefined user information.

4. The system of claim 1, wherein said content processing device is configured to decode information from said multi-media content.

5. The system of claim 4, wherein said content processing device further includes a memory module for storing said information.

6. The system of claim 1, wherein said content processing device is configured to create a set of bookmark data for each bookmark.

7. The system of claim 6, wherein each set of bookmark data includes a unit identifier for said content processing device, metadata relating to each bookmarked portion of multi-media content, and contents of a rolling capture buffer of said content processing device.

8. The system of claim 6, wherein said bookmark data contains no audio or video content.

9. The system of claim 1, wherein said content processing device is in communication with at least one server, and wherein bookmark data for each bookmark is transmitted from said content processing device to said at least one server.

10. The system of claim 9, wherein said at least one server includes an encoding server configured to receive multi-media content from said first network.

11. The system of claim 10, wherein said at least one server further includes a storage server and wherein bookmark data from said content processing device is transmitted to said storage server.

12. The system of claim 11, wherein said encoding server transmits and stores audio and video content to said storage server.

13. The system of claim 12, wherein said storage server is configured to correlate bookmark data from said content processing device to the audio and video content stored in said storage server.

14. The system of claim 9, wherein said at least one server communicates to said content processing device through a second network.

15. The system of claim 9, wherein said at least one server is in communication with at least one interactive platform, said at least one interactive platform being configured to receive a notification of bookmarks stored in said at least one server.

16. The system of claim 15, wherein said interactive platform is an Internet connected device.

17. The system of claim 15, wherein said interactive platform is at least one of a computer, a personal digital assistant and a wireless phone.

18. The system of claim 15, wherein said at least one server is in communication with said at least one interactive platform through the second network.

19. The system of claim 9, wherein said at least one server includes a search server configured to perform a query on at least a portion of said bookmark data.

20. A method, comprising:
receiving multi-media content from a first network at a content processing device;
creating a bookmark representing at least a portion of the multi-media content; and
creating a set of bookmark data for each bookmark.

21. The method of claim 20, further including transmitting said bookmark data to at least one server through a second network.

22. The method of claim 21, further including transmitting a notification to an interactive platform from said at least one server.

23. The method of claim 22, wherein said notification is transmitted to said interactive platform from said at least one server through a third network.

24. The method of claim 21, further including accessing said bookmark data from said at least one server through at least one of a web interface or portal.

25. The method of claim 21, further including accessing said bookmark data from said at least one server through said content processing device.

26. The method of claim 21, further including performing a query of one or more search terms relating to information in said bookmark data.

27. A method, comprising:
receiving multi-media content from a first network;
receiving bookmark data from a content processing device through the first network;
correlating the bookmark data to respective portions of the multi-media content to create a bookmark;
transmitting the bookmark to an interactive platform in response to a request from a user.

28. A system, comprising:
a first computing device that includes an application configured to:
receive multi-media content from a first network;
create a bookmark representing at least a portion of the multi-media content upon receiving a signal from a control device; and
create a set of bookmark data for each bookmark.

29. The system of claim 28, further comprising:
a second computing device that includes an application configured to:
receive the set of bookmark data; and
transmit a notification of the bookmark to an interactive platform.

30. The system of claim 29, wherein said second computing device is further configured to query one or more terms of the bookmark data using a search engine.

31. The system of claim 30, wherein said second computing device is further configured to transmit search results from the query and to the interactive platform.
